(19) United States
(12) Patent Application Publication
(10) Pub. No.: US 2016/0290044 A1
(43) Pub. Date: Oct. 6, 2016

(54) SHUTTER ROLLING SYSTEM AND METHOD

(71) Applicant: ROLL PROFILE LTD., Karmiel (IL)

(72) Inventors: Avi SOMECH, Ramat Gan (IL); Itamar Ohayon, Kiryat Ata (IL)

(21) Appl. No.: 15/082,017

(22) Filed: Mar. 28, 2016

(30) Foreign Application Priority Data
Mar. 29, 2015 (IL) 238005

(51) Int. Cl. E06B 9/74; E06B 9/58; E06B 9/44

(52) U.S. Cl. CPC E06B 9/74; E06B 9/44; E06B 9/58; E06B 2009/583; E06B 2009/785

(57) ABSTRACT

A shutter rolling mechanism comprises at least two rolling means adapted to roll a shutter around them the rolling means are disposed with their rolling axes parallel and coinciding with each other within an installation space. A driving means is attached to at least one of the rolling means, and a shutter is attached at one end to one of the two rolling means and is disposed so as to roll over one of the rolling means and then over the other rolling means when in stowing action, and to be rolled from the rolling means when in deploying action. The driving means is adapted to drive the rolling means to wind the shutter over the rolling means in one rotational direction and to deploy the shutter in a second rotational direction.

### CROSS REFERENCE TO RELATED APPLICATIONS

This application claims the benefit of Israeli Patent Application No. 238005, filed on Mar. 29, 2015 and entitled SHUTTER ROLLING SYSTEM AND METHOD, which is incorporated herein by reference in its entirety.

### BACKGROUND OF THE INVENTION

Known mechanisms for deploying and stowing rollable shutters or curtains typically comprise a rolling cylinder adapted to have the rollable shutter been rolled and wrapped around the cylinder when in stowed position and unrolled when in deployed position. In order to roll out the shutter, the cylinder may be turned in the unwind direction, manually or electrically, to unwind and deploy the shutter off the cylinder, typically using guiding tracks, over an opening such as a window or entrance opening. Since such shutter has a non-negligible thickness, when the shutter is rolled over the rolling cylinder, the overall radius of the rolled shutter grows as the number of turns of shutter on the roller grows. This effect imposes a substantial drawback—a shutter with a given thickness and a given required length of the shutter when in deployed position dictates the overall radius of the rolled shutter when in stowed position. In cases where structural limitations impose limits on the overall radius of the rolled shutter, such as when the stowed shutter needs to be installed between two internal faces of a wall having defined thickness, the maximum length of the deployed shutter may be limited to a length shorter than needed to a given opening.

FIG. 1 shows a typical installation of shutter rolling mechanism 100 as known in the art, installed within a cavity between two side faces 101A and 101B of a wall 101. The required maximum length of shutter 120 is dictated by the height Hₒₚₑₙ of the respective opening 106 that is to be covered by shutter 120. Shutter 120 may be rolled to its stowed position over roller 110 having a radius of Rᵣₒₗₗₑᵣ. The maximum length of shutter 120 that may be rolled over roller 110 is dictated by the thickness Tₛₕᵤₜₜₑᵣ_{_}_{thick} of shutter 120 and the available free space in section 102 for the rolled shutter, e.g., the free space W_{mech} between the inner sides of the two side faces 101A and 101B of wall 101, which sets the maximum rollable radius Rᵣₒₗₗₘₐₓ. In many cases, when the thickness of the shutter and the length of the fully opened shutter dictate a required Rᵣₒₗₗₘₐₓ that exceeds the available free space W_{mech} between two faces 101A and 101B of a wall 101, a bulge needs to be formed in order to enable rolling the full length of the shutter in stowed position. This is a drawback both with respect to structural complexity and to aesthetic aspects.

There is need to enable installing a shutter rolling system that will allow lengthy shutters to be fully stowed even where the installation space limits at least one dimension of the available space for the rolled shutter.

### SUMMARY OF THE INVENTION

A shutter rolling mechanism is disclosed comprising at least two rolling means adapted to roll a shutter around them, said rolling means are disposed with their rolling axes parallel and coinciding each other within an installation space, a driving means attached to at least one of said rolling means, and a shutter attached at one end to one of said two rolling means and disposed so as to roll over one of said rolling means and then over the other rolling means when in stowing action and to be rolled from said rolling means when in deploying action. According to some embodiments, the shutter rolling mechanism further comprises driving means to drive said rolling means so as to wind said shutter over said rolling means in one rotational direction and to deploy said shutter in a second rotational direction.

According to yet additional embodiments, the overall length of a single winding of the shutter over said rolling means equals to the actual perimeter of a single rolling means plus two times the distance between the axes of said rolling means.

According to yet additional embodiments, the axes of said rolling mechanism are disposed in a common vertical plane.

According to yet additional embodiments, the axes of said rolling mechanism are disposed in a common horizontal plane.

According to yet additional embodiments, the axes of said rolling mechanism are disposed in an installation space having at least one vertical section and one horizontal section.

According to yet additional embodiments, said rolling means is one from a list comprising cylindrical rollers and set of rollers disposed along a semi-circle.

A method for stowing a shutter is disclosed, the method comprising providing shutter rolling mechanism comprising at least two rolling means adapted to roll a shutter around them, said rolling means being disposed with their rolling axes parallel and coinciding with each other within an installation space, a driving means attached to at least one of said rolling means, and a shutter attached at one end to one of said two rolling means and disposed so as to roll over one of said rolling means and then over the other rolling means. The method further comprises driving said shutter rolling mechanism to the stow direction so as to roll said shutter over said rollers and stopping said driving when said shutter is fully stowed.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically presents a shutter rolling mechanism as known in the art;

FIG. 2A is a schematic illustration of a shutter rolling mechanism according to embodiments of the present invention;

FIGS. 2B and 2C are schematic illustrations of additional shutter rolling mechanisms according to some embodiments of the present invention;

FIG. 2D is a schematic illustration of an additional shutter rolling mechanism according to some embodiments of the present invention;

FIG. 2E schematically presents an additional rolling mechanism according to some embodiments of the present invention; and

FIGS. 3A and 3B are flow diagrams presenting operation of a shutter rolling mechanism according to some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

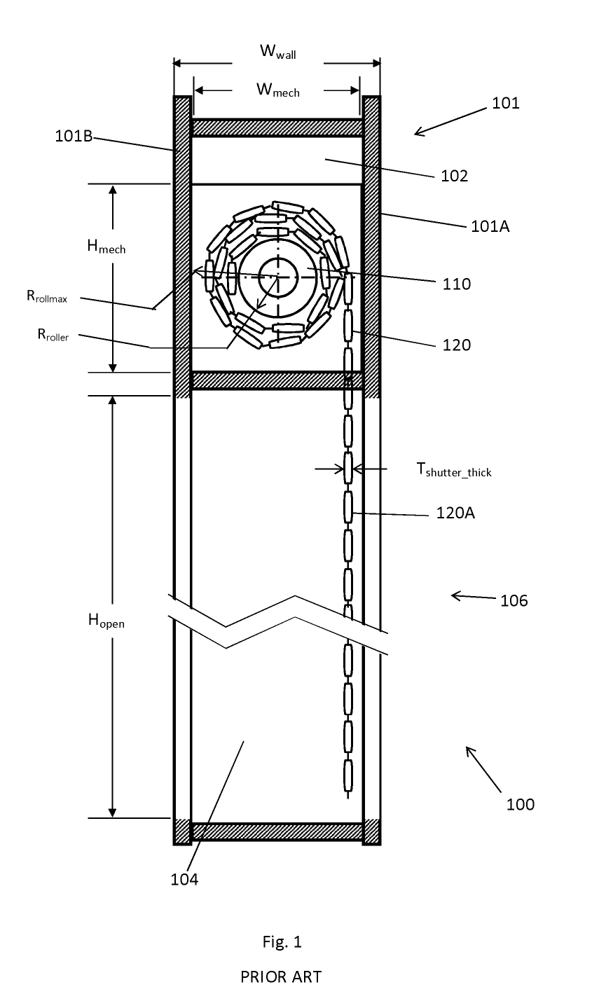

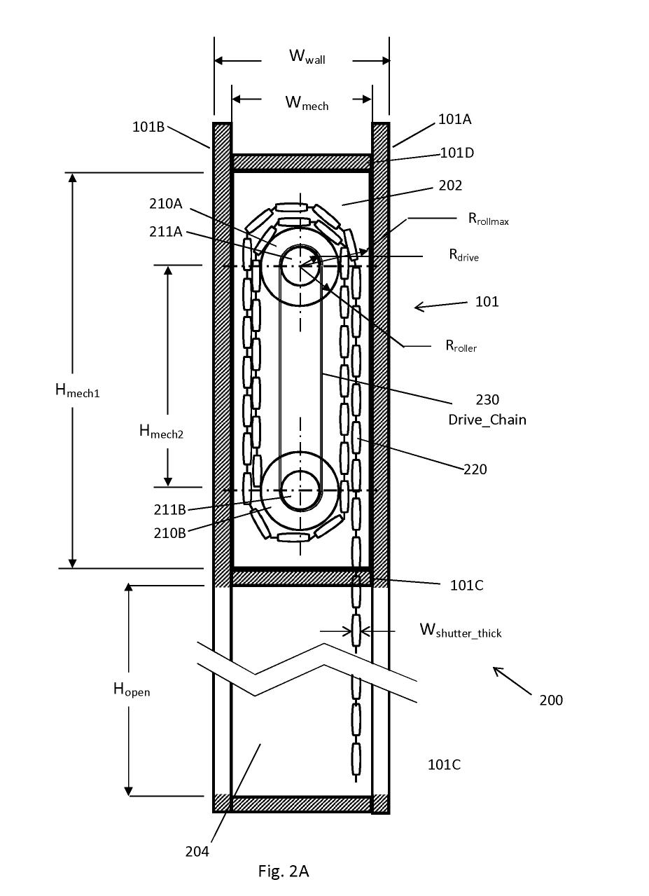

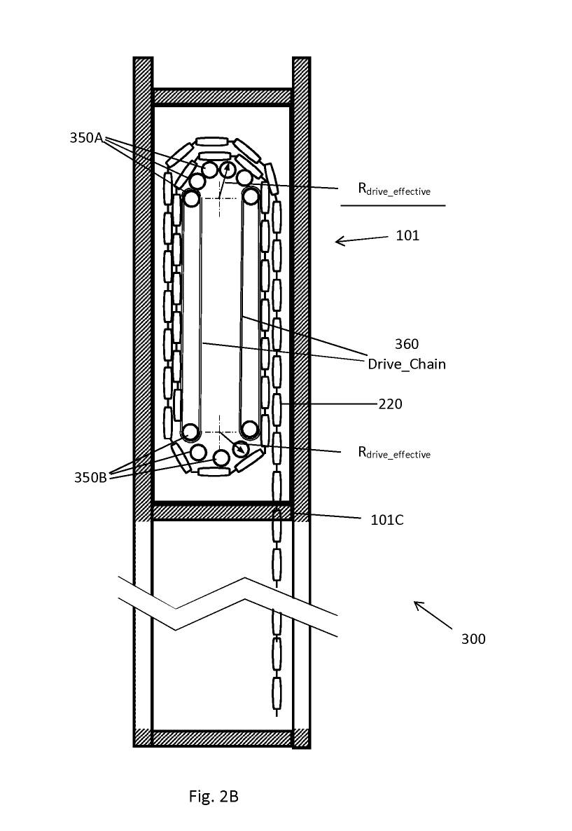

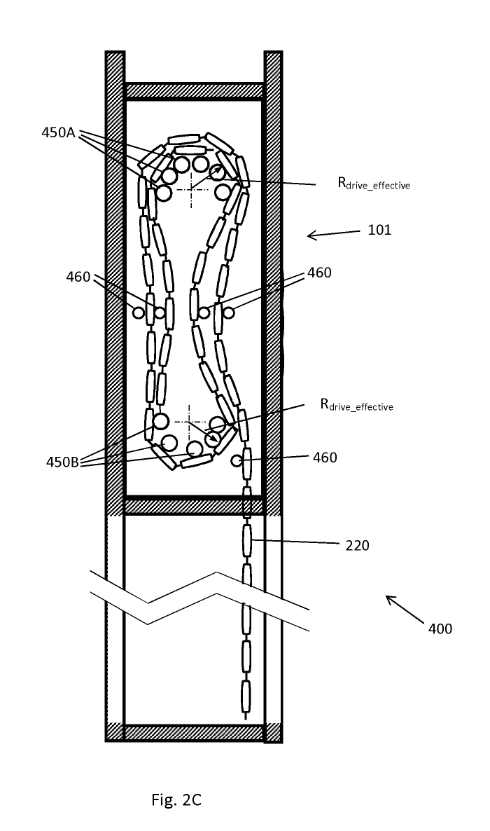

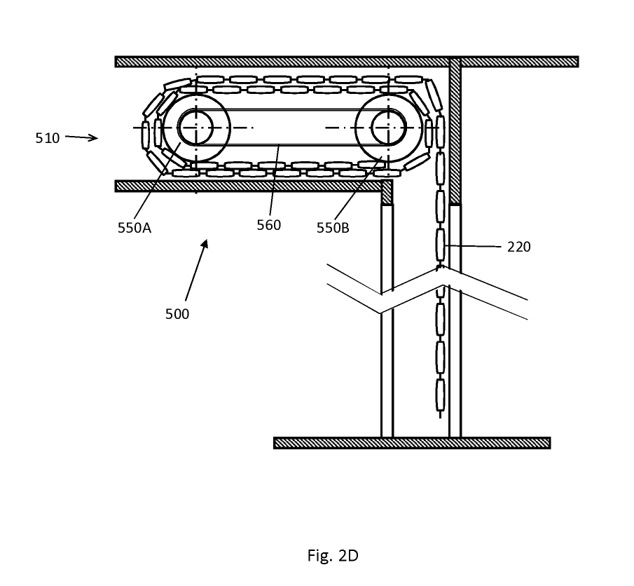

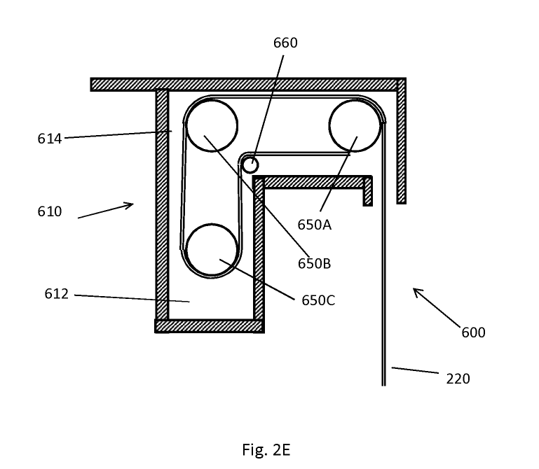

The following discussions of installation spaces for housing shutter rolling mechanisms consider, if not specifically indicated otherwise, the two Cartesian dimensions which are perpendicular to the rolling axis of the discussed rolling mechanism and to each other as a first and a second installation mechanisms. Such first dimension is, for example, a dimension parallel to the W_{mech} dimension and such second dimension is a dimension parallel to dimension H_{mech1} (FIG. 2A). Typically the space for installation of shutter rolling mechanism is limited in one dimension, e.g., the width dimension (width of the wall within which the mechanism is to be installed). However, in many cases, the shutter rolling installation space may be less limited in another dimension, for example in its height dimension. Some embodiments of the present invention take advantage of such installation spaces having one dimension longer than another dimension by providing shutter rolling mechanism that enable stowing the shutter/curtain in a stowing space having one dimension longer than another dimension, as differs from known stowing mechanism, such as mechanism 100 of FIG. 1.

Reference is made now to FIG. 2A which is a schematic illustration of shutter rolling mechanism 200 according to some embodiments of the present invention. Shutter rolling mechanism 200 may be adapted to be installed within an existing installation space 202 formable in wall 101, between two outer faces 101A and 101B of that wall. The distance W_{mech} between wall faces 101A and 101B parallel to the horizontal dimension of installation space 202 is typically dictated by the structure of the respective wall. Yet, typically the distance H_{mech1}, extending parallel to the vertical dimension of installation space 202, available for installation space between lower beam 101C of installation space 202 and upper beam 101D of installation space 202 is more flexible and may typically be set to be longer than W_{mech}, without negatively affecting the aesthetic aspect and without imposing undesired structural constraints on wall 101.

Advantage is taken of this effect according to some embodiments of the present invention. Shutter rolling mechanism 200 may be adapted to roll and stow shutter 220 over a rolling mechanism having one dimension longer than another dimension. Accordingly, according to one embodiment of the present invention, shutter rolling mechanism 200 may comprise two rollers 210A and 210B arranged parallel to each other with their rolling axes parallel to each other in installation space 202 and adapted to roll shutter 220 over roller 210A and then over roller 210B and so forth. Accordingly, the length of a single winding of rolled shutter 220 over rollers 210A and 210B is longer by 2×Hmech2, where H_{mech2} is the distance between the axes of rollers 210A and 210B, compared to known shutter rolling mechanisms using a single roller of the same radius Rroller within wall having the same internal installation space width W_{mech}. Accordingly, the rollable length of shutter 220 may grow longer as the available installation height H_{mech1} is larger. Rollers 210A and 210B may mechanically be engaged so as to roll together at the same direction and same rotational speed, for example by driving sprockets 211A, 211B and driving chain 230. Rolling of rollers 210A, 210B may be powered by an electrical motor (not shown), manual mechanism (not shown) or any other rolling powering means as known in the art. Shutter rolling mechanism 200 may further comprise sensors to indicate fully opened and fully rolled positions of shutter 220 (not shown), rotation encoder to indicate actual deployed/stowed length of the shutter (not shown), guiding tracks to guide shutter 220 as it is deployed or stowed (not shown), controller to enable automatic deploy/stow operations (not shown), remote control transceiver to enable remote control of shutter rolling mechanism 200 (not shown), and the like, as is known in the art.

Similarly, additional configurations of shutter rolling mechanisms that require stowing space having vertical dimension longer than its horizontal dimension, are presented in FIGS. 2B and 2C which are schematic illustrations of shutter rolling mechanisms 300 and 400 according to some embodiments of the present invention. FIG. 2B presents shutter rolling mechanism 300 comprising two sets of mini rollers 350A and 350B, each forming a rolling trajectory shaped as a semi-circle, the imaginary center of the first and the second semi-circles are located at a distance from each other similarly to distance H_{mech2} of FIG. 2A, thus forming a rolling mechanism that may stow a shutter as long as shutter 220 of FIG. 2A. Rolling mechanism 300 may further comprise driving chains 360 that may be used for conveying drive from one end of mechanism 300 (e.g., mini rollers 350A) to the other end (e.g., mini rollers 350B) and may further provide mechanical support to shutter 220 when in stowed position. FIG. 2C presents yet another configuration for extended shutter rolling mechanism 400. Rolling mechanism 400 may comprise two sets of mini rollers 450A and 450B each forming a rolling trajectory shaped as a semi-circle, the imaginary center of the first and the second semi-circles are located at a distance from each other similarly to distance H_{mech2} of FIG. 2A, thus forming a rolling mechanism that may stow a shutter as long as shutter 220 of FIG. 2A. Rolling mechanism 400 may further comprise tensioning mini rollers 460 located substantially in similar distance between the imaginary centers of the semi-circles and in locations that allow fluent movement of shutter 220 over the mini rollers while keeping shutter 220 sufficiently tensioned. As may be clearly seen in FIG. 2C, in some embodiments using this configuration the stowed shutter may be even longer than that of the configuration of FIG. 2B having the same H_{mech2}.

Some constructions may dictate installation spaces for the stowed shutter having their longer dimension extending in different direction than the vertical dimension as presented FIGS. 2A to 2C. Reference is made to FIG. 2D which is a schematic illustration of shutter rolling mechanism 500 according to some embodiments of the present invention adapted to stow and deploy shutter 220, which takes advantage of installation space 510 having its horizontal dimension longer than its vertical dimension. Rolling mechanism 500 may comprise two rollers 550A and 550B installed spaced apart horizontally parallel to each other similarly to rollers 210A and 210B but located in a common horizontal plane. Rolling mechanism 500 may further comprise driving chain 560, similarly to driving chain 230 of FIG. 2A. It should be apparent to those skilled in the art that the configurations of FIGS. 2B and 2C may be adapted for installation in an installation space such as installation space 510 having its longer dimension horizontal, with minor modifications.

In some cases, the installation space available for installing shutter rolling mechanism may have a shape that is more complicated than a rectangle with one longer dimension and one shorter dimension, as in FIGS. 2A-2D. For example, an available installation space for shutter rolling mechanism may comprise two or more sub-spaces forming a non-single-linear space. Reference is made to FIG. 2E which schematically presents rolling mechanism 600 according to some embodiments of the present invention, installed in non-single-linear installation space 610 comprising vertical sub-space and 612 and horizontal sub-space 614. In order to take advantage of installation space 610, rollers 650A, 650B and 650C and mini roller 660 may be located as seen in FIG. 2E, to form rolling path that takes advantage of the specific form of installation space 610. It would apparent to those skilled in the art that other forms of installation spaces may be used according to some embodiments of the present invention in order to provide rolling mechanism that supports long shutters.

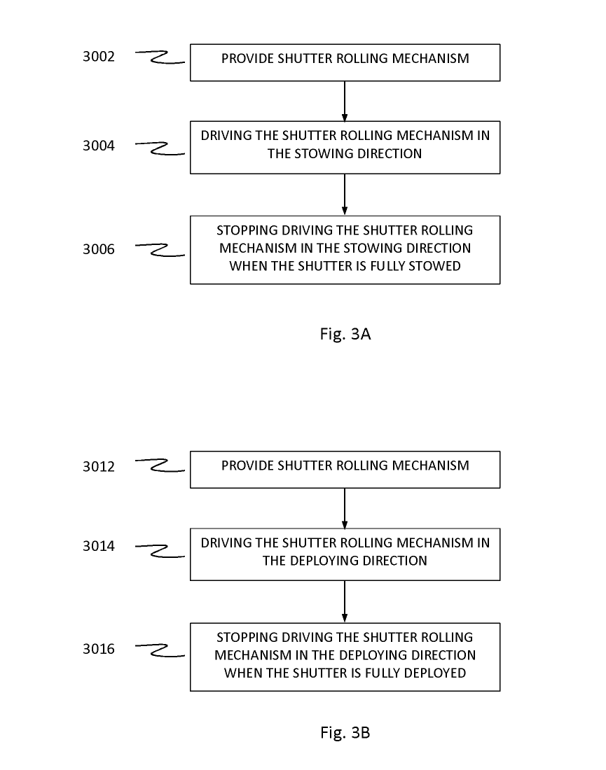

Reference is made now to FIGS. 3A and 3B which are flow diagrams presenting operation of a shutter rolling mechanism according to some embodiments of the present invention. FIG. 3A is a flow diagram presenting stowing of a shutter according to some embodiments of the present invention. A shutter rolling mechanism built and operative according to embodiments of the present invention is provided [block 3002]. The rolling mechanism is driven in the stowing direction [block 3004] and is stopped when the shutter is fully stowed [block 3006].

FIG. 3B is a flow diagram presenting deploying of a shutter according to some embodiments of the present invention. A shutter rolling mechanism built and operative according to embodiments of the present invention is provided [block 3012]. The rolling mechanism is driven in the deploying direction [block 3014] and is stopped when the shutter is fully deployed [block 3016].

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A shutter rolling mechanism comprising:
at least two rolling means adapted to roll a shutter around them, said rolling means are disposed with their rolling axes parallel and coincide each other within an installation space;
a driving means attached to at least one of said rolling means; and
a shutter attached at one end to one of said two rolling means and disposed so as to roll over one of said rolling means and then over the other rolling means when in stowing action and to be rolled from said rolling means when in deploying action.

2. The shutter rolling mechanism of claim 1 further comprising driving means to drive said rolling means so as to wind said shutter over said rolling means in one rotational direction and to deploy said shutter in a second rotational direction.

3. The shutter rolling mechanism of claim 1 wherein the overall length of a single winding of said shutter over said rolling means equals to the actual perimeter of a single rolling means plus two times the distance between the axes of said rolling means.

4. The shutter rolling mechanism of claim 1 wherein the axes of said rolling mechanism are disposed in a common vertical plane.

5. The shutter rolling mechanism of claim 1 wherein the axes of said rolling mechanism are disposed in a common horizontal plane.

6. The shutter rolling mechanism of claim 1 wherein the axes of said rolling mechanism are disposed in an installation space having at least one vertical section and one horizontal section.

7. The shutter rolling mechanism of claim 1 wherein said rolling means is one from a list comprising cylindrical rollers and set of rollers disposed along a semi-circle.

8. A method for stowing a shutter comprising:
providing shutter rolling mechanism comprising:
at least two rolling means adapted to roll a shutter around them, said rolling means are disposed with their rolling axes parallel and coincide each other within an installation space;
a driving means attached to at least one of said rolling means; and
a shutter attached at one end to one of said two rolling means and disposed so as to roll over one of said rolling means and then over the other rolling means;
driving said shutter rolling mechanism to the stow direction so as to roll said shutter over said rollers; and
stopping said driving when said shutter is fully stowed.

9. A method for deploying a shutter comprising:
providing shutter rolling mechanism comprising:
at least two rolling means adapted to roll a shutter around them, said rolling means are disposed with their rolling axes parallel and coincide each other within an installation space;
a driving means attached to at least one of said rolling means; and
a shutter attached at one end to one of said two rolling means and disposed so as to roll over one of said rollers and then over the other rolling means;
driving said shutter rolling mechanism to the deploy direction so as to roll said shutter over said rolling means; and
stopping said driving when said shutter is fully deployed.
